(19) United States
(12) Patent Application Publication
(10) Pub. No.: US 2002/0197906 A1
(43) Pub. Date: Dec. 26, 2002

(54) Electrical connector for connecting flat flexible circuitry to discrete terminal pins

(76) Inventors: Robert M. Fuerst, West Bloomfield, MI (US); Yves LePottier, Grosse Pointe, MI (US); Brian Richard Moser, Fenton, MI (US)

Correspondence Address: MOLEX INCORPORATED, 2222 WELLINGTON COURT, LISLE, IL, 60532, US

(21) Appl. No.: 09/804,099

(22) Filed: Jun. 22, 2001

(51) Int. Cl. H01R 12/24

(52) U.S. Cl. 439/495

(57) ABSTRACT

A connector is provided for electrically interconnecting the conductors of a flat flexible circuit to a plurality of discrete terminal pins. The connector includes a dielectric housing having a front mating face and a rear terminating face. A plurality of terminal pin-receiving passages are provided in the mating face. A flat circuit-receiving receptacle is provided in the terminating face in communication with the passages. A circuit carrier is insertable into the receptacle of the housing and includes an attachment portion for attaching the flat flexible circuit of the carrier with the conductors of the circuit facing away from the carrier toward the terminal pin receiving passages. Insertion of the pins in the passages causes the pins to engage the conductors of the circuit.

### FIELD OF THE INVENTION

This invention generally relates to the art of electrical connectors and, particularly, to connectors for electrically interconnecting a plurality of discrete terminal pins to the conductors of a flat flexible circuit.

### BACKGROUND OF THE INVENTION

A flat flexible circuit conventionally includes an elongated flat flexible dielectric substrate having laterally spaced strips of conductors on one or both sides thereof. The conductors may be covered with a thin, flexible protective layer on one or both sides of the circuit. If protective layers are used, cutouts are formed therein to expose the underlying conductors at desired contact locations where the conductors are to engage the conductors of a complementary mating connecting device which may be a second flat flexible circuit, a printed circuit board or the terminals of a mating connector.

A wide variety of connectors have been designed over the years for terminating or interconnecting flat flexible circuits with complementary mating connecting devices. However, there has not been a reliable and cost effective system for electrically connecting a plurality of discrete terminal pins to flat flexible circuitry. The present invention is directed to satisfying that need and solving the problems associated therewith. The present invention is extremely simple, inexpensive and reliable.

### SUMMARY OF THE INVENTION

An object, therefore, of the invention is to provide a new and improved electrical connector for interconnecting the conductors of a flat flexible circuit to a plurality of discrete terminal pins.

In the exemplary embodiment of the invention, the connector includes a dielectric housing having a front mating face and a rear terminating face. The front mating face has a plurality of terminal pin-receiving passages. The terminating face has a flat circuit-receiving receptacle which is in communication with the passages. A circuit carrier is insertable into the receptacle and includes an attachment portion for attaching the flat flexible circuit to the carrier, with the conductors of the circuit facing away from the carrier toward the terminal pin-receiving passages. Insertion of the pins into the passages causes the pins to engage the conductors of the circuit.

The circuit carrier preferably is fabricated of metal material and includes a spring loaded mouth into which the terminal pins are inserted into engagement with the conductors of the circuit. The housing includes cam means engageable with the circuit carrier to open the spring loaded mouth a given amount to apply a given contact force between the terminal pins and the conductors of the circuit. Complementary interengaging latch means are provided between the circuit carrier and the housing to hold the carrier in the receptacle of the housing.

As disclosed herein, at least a portion of the circuit carrier is generally U-shaped to define a pair of legs. A first of the legs forms the attachment portion of the carrier. A second of the legs forms a mounting portion for mounting the circuit carrier in the housing. The first leg has a leading edge about which the flat flexible circuit is wrapped, with the conductors of the circuit facing away therefrom. A raised area is provided immediately inside the leading edge of the first leg and over which the flat flexible circuit is wrapped. The raised area forms contact portions of the terminals for engaging the terminal pins. The raised area may be provided by a yieldable backing strip adhered to the first leg. The distal ends of the legs define the mouth into which the terminal pins are inserted. The cam means for opening the mouth comprises at least one cam ramp on the housing for engaging the first leg of the circuit carrier to open the mouth automatically in response to inserting the circuit carrier into the receptacle in the housing.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a top perspective view of a connector assembly including the connector of the invention in unmated condition relative to a complementary mating header connector;

FIG. 2 is a bottom perspective view of the assembly of FIG. 1 in unmated condition;

FIG. 3 is a top perspective view of the assembly of FIG. 1 in mated condition;

FIG. 4 is a bottom perspective view of the mated assembly of FIG. 3;

FIG. 5 is a top perspective view of the connector of the invention in unassembled condition;

FIG. 6 is a bottom perspective view of the unassembled connector of FIG. 5;

FIG. 7 is a top perspective view of the circuit carrier of the connector;

FIG. 8 is a bottom perspective view of the circuit carrier;

FIG. 9 is an enlarged section taken generally along 9-9 of FIG. 5;

FIG. 10 is an enlarged section taken generally along line 10-10 in FIG. 1;

FIG. 11 is an enlarged section taken generally along line 11-11 of FIG. 3;

FIGS. 12 and 13 are views similar to FIGS. 8 and 7, respectively, but showing a different circuit carrier wherein the resilient fingers have been replaced by a resilient backing structure; and

FIG. 14 is a view similar to that of FIG. 1, but the connector of the invention is shown for use with a plurality of discrete terminal pins individually crimped to a plurality of electrical conductors.

### DETAILED DESCRIPTION OF THE PREFERRED EMBODIMENTS

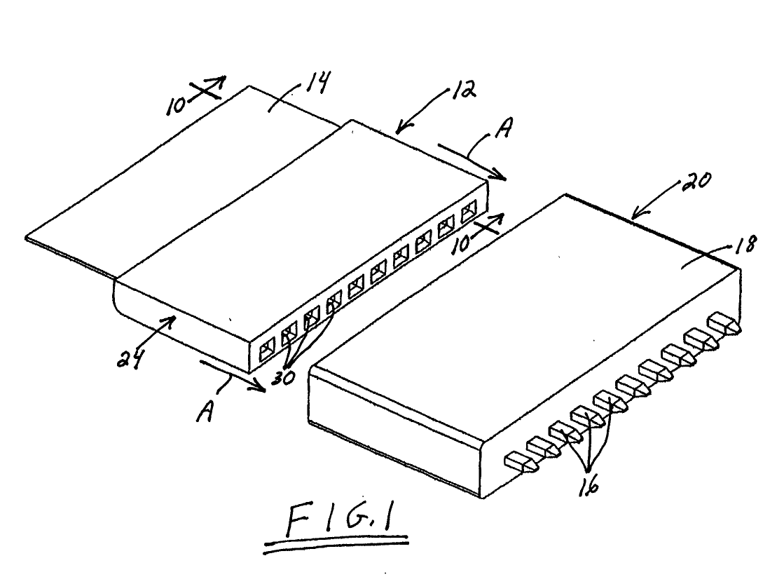

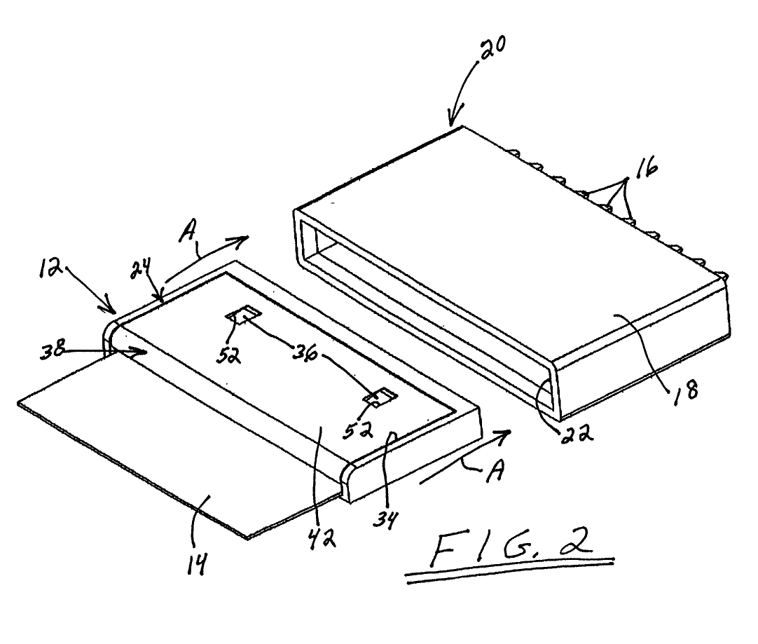

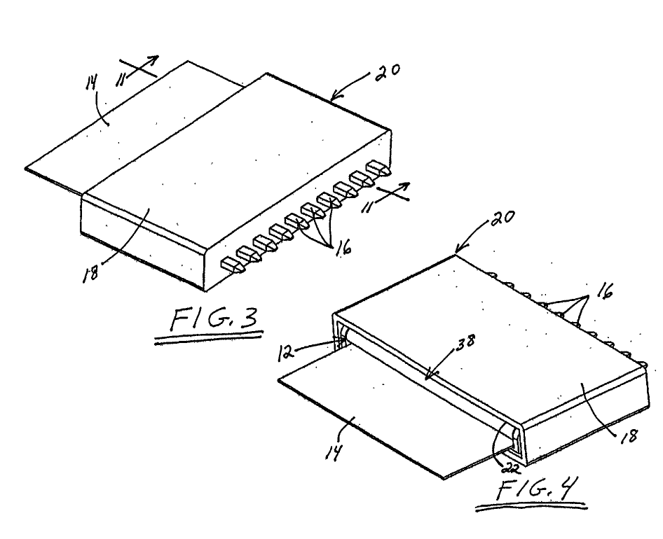

Referring to the drawings in greater detail, and first to FIGS. 1-4, the invention is embodied in an electrical connector, generally designated 12, for electrically interconnecting the conductors of a flat flexible circuit 14 to a plurality of discrete terminal pins 16. As shown herein, terminal pins 16 are mounted in a housing 18 of a complementary mating header connector, generally designated 20. The terminal pins extend into the interior of a cavity 22 within housing 18 of header connector 20. Hereinafter, connector 12 according to the invention will be called the “circuit connector”. The circuit connector is mateable with header connector 20 in the direction of arrows “A” (FIGS. 1 and 2), by inserting the circuit connector into cavity 22 of header connector 20 as seen in FIGS. 3 and 4.

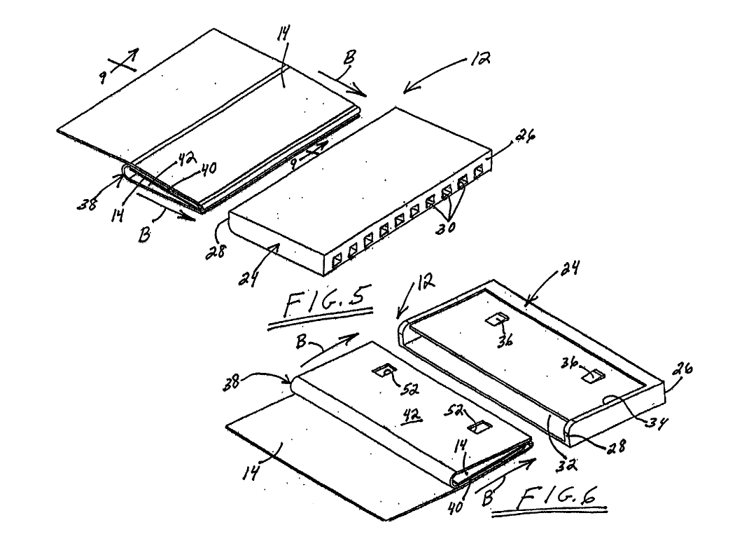

Referring to FIGS. 5 and 6 in conjunction with FIGS. 1-4, circuit connector 12 includes a dielectric housing, generally designated 24, having a front mating face 26 and a rear terminating face 28. A plurality of terminal pin receiving passages 30 (FIG. 5) are provided in mating face 26. A flat circuit receiving receptacle 32 (FIG. 6) is provided in rear terminating face 28. As will be seen hereinafter, the receptacle communicates with passages 30. A recessed area 34 is formed in the bottom of housing 24. Finally, a pair of ramped latch bosses 36 project from the housing within recessed area 34 as seen in FIG. 6. Housing 24 may be molded of plastic material.

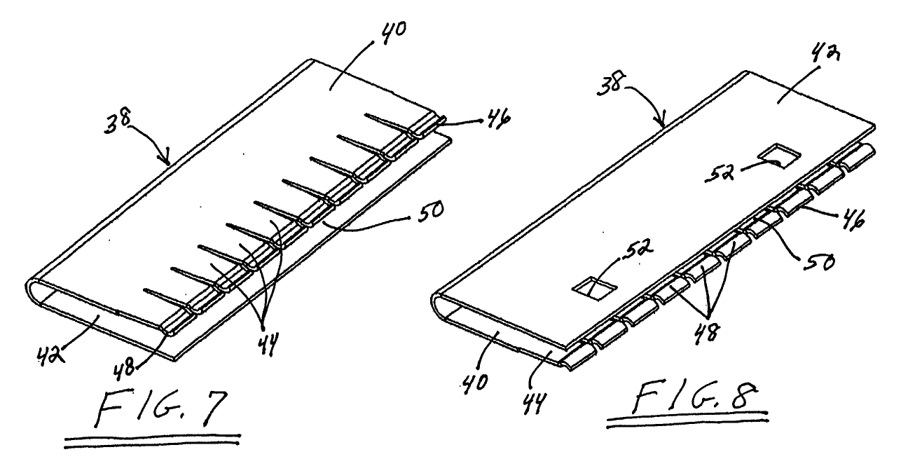

Referring to FIGS. 7 and 8 in conjunction with FIGS. 5 and 6, circuit connector 12 includes a circuit carrier, generally designated 38, which is insertable into receptacle 32 in housing 24 in the direction of arrows “B” (FIGS. 5 and 6). The circuit carrier is fabricated of a metal material having spring-loading capabilities. The circuit carrier is generally U-shaped to define a top leg 40 and a bottom leg 42. Top leg 40 forms an attachment portion of the carrier about which flat flexible circuit 14 is wrapped as seen in greater detail hereinafter. The top leg has a plurality of flexible or resilient fingers 44 which combine to form a composite leading edge 46 about which circuit 14 is wrapped, with the conductors (not shown) of the circuit facing away from the carrier toward pin-receiving passages 30 of housing 24 when the circuit carrier and circuit are inserted into receptacle 32 of the housing. Fingers 44 have raised areas 48 which face inwardly toward bottom leg 42. The raised areas define convex surfaces which form contact portions behind the conductors of the flat flexible circuit for providing good engagement with terminal pins 16. In essence, a mouth 50 is defined between legs 40 and 42 at the distal ends thereof inside raised areas 48. Finally, circuit carrier 38 includes a pair of latch apertures 52 (FIG. 8) for interengagement with latch bosses 36 (FIG. 6) of housing 24 to hold the circuit carrier in receptacle 32 of the housing as seen best in FIG. 2. It also can be seen in FIG. 2 that, when the circuit carrier is assembled within the housing, bottom wall 42 of the circuit carrier is disposed within recessed area 34 generally flush with the bottom of the housing.

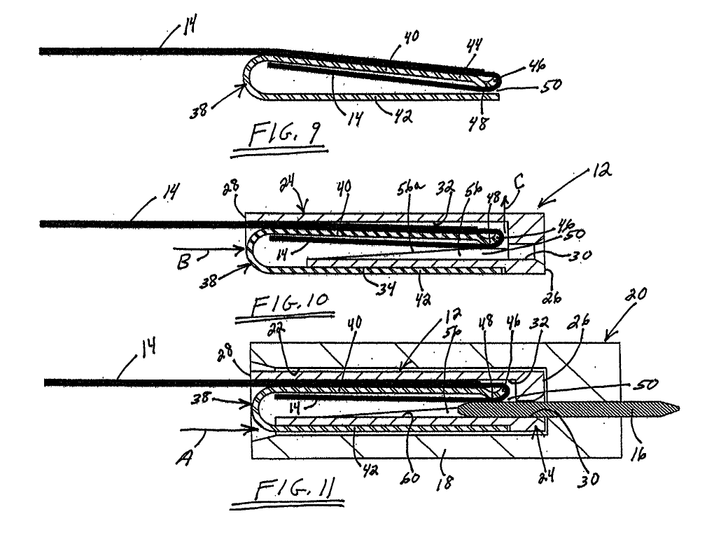

FIGS. 9-11 show the sequence of assembly of circuit connector 12 and the mating of the circuit connector within cavity 22 of header connector 20. Specifically, FIG. 9 shows flat flexible circuit 14 wrapped about leading edge 46 of leg 40 of circuit carrier 38. It can be seen that raised areas 48 of fingers 44 extend the flexible circuit inwardly immediately inside edge 46 at the distal end of leg 40. FIG. 9 also shows the metal circuit carrier in an unstressed condition, wherein the distal ends of legs 40 and 42 are relatively close to each other, whereby mouth 50 is relatively narrow.

FIG. 10 shows the subassembly of circuit carrier 38 and flat flexible circuit 14 having been inserted in the direction of arrow “B” into receptacle 38 of housing 24. When inserted, bottom leg 42 of the circuit carrier is disposed within recessed area 34 at the bottom of the housing. FIG. 10 also shows a cam means within receptacle 32 of the housing for engaging top leg 40 and flat circuit 14 to expand or open mouth 50. Specifically, a plurality of elongated cam ramps 56 are formed within the housing and are located between the plurality of pin-receiving passages 30 so that the cam ramps do not interfere with insertion of the pins into the circuit connector. The cam ramps define inclined surfaces 56a which engage raised areas 48 at leading edge 46 of top leg 40 to bias the top leg upwardly in the direction of arrow “C”. Actually, the cam ramps engage the overwrapped flexible circuit between the conductors of the circuit. Nevertheless, with bottom leg 42 of the circuit carrier fixed against the bottom of housing 24, raising top leg 40 in the direction of arrow “C” stores energy in the top leg of spring metal material, effectively spring-loading the leg.

FIG. 11 shows circuit connector 12 having been inserted in the direction of arrow “A” into cavity 22 of housing 18 of header connector 20. Upon mating of the connectors as shown, terminal pins 16 enter passages 30 in mating face 26 of housing 24 of the circuit connector. The terminal pins move into mouth 50 and engage the conductors on the outside of flat flexible circuit 14 which has been wrapped about leading edge 46 of top leg 40 of circuit carrier 38. The pins ride along a rigid interior bottom wall 60 of the housing within receptacle 32. The cross-dimensions of the pins are sufficiently greater than the distance between bottom wall 60 and raised areas 48 to create a good positive electrical contact between the terminal pins and the conductors on the outside of flat flexible circuit 14 which has been wrapped around leading edge 46 of top leg 40 of the circuit carrier.

From the foregoing, it can be understood that the connector of the invention has a number of advantages. A key advantage is the ability of circuit carrier 38, with its opposing legs 40 and 42, to contain all required normal forces within a single component, thereby eliminating stress relaxation of other components such as plastic housing 24. This is especially important as the number of terminal pins increases, because the total normal force of the system also increases. Pre-loading the circuit carrier has the advantage of generating high normal forces with minimal displacement of leg 40 of the carrier. Insertion forces also are reduced because the terminal pins are not used to spread the legs of the circuit carrier from its unstressed condition. Still further, moving the leading edge of the flexible circuit away from the tips of the terminal pins reduces skiving damage upon initial insertion of the terminal pins into the connector.

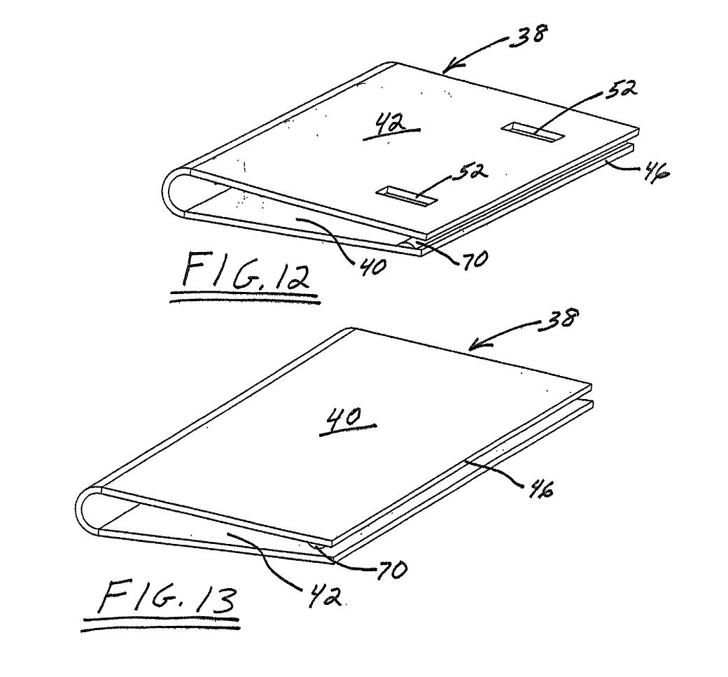

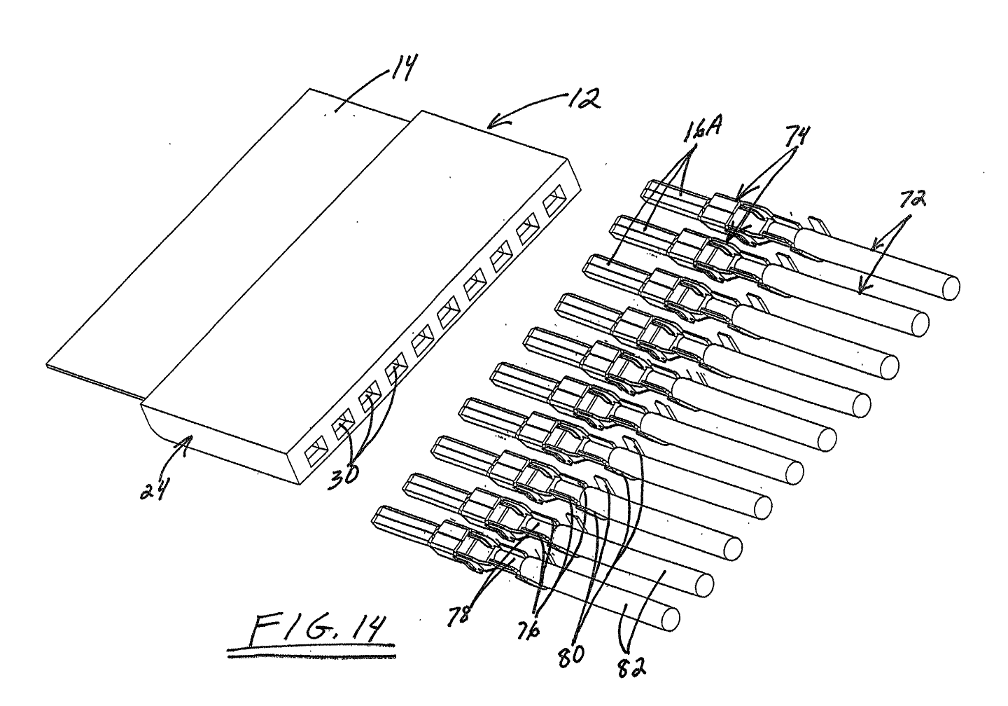

FIGS. 12 and 13 show an alternate embodiment of circuit carrier 38, and like reference numerals have been applied in FIGS. 12 and 13 corresponding to like components already described in relation to FIGS. 1-11. In particular, resilient fingers 44 (FIGS. 7 and 8) have been replaced by a yieldable backing structure or strip 70 of elastomeric material such as silicone rubber or the like. The yieldable backing strip is attached or adhered, as by appropriate adhesive, to the inside of leg 40 of the circuit carrier immediately inside edge 46 of the leg. Yieldable backing strip 70 performs the resiliency function of flexible fingers 44 as well as providing the raised area 48 of the first embodiment.

FIG. 14 shows an application of the invention wherein electrical connector 12 is used with a plurality of discrete terminal pins 16A respectively terminated to a plurality of discrete conductors, generally designated 32, rather than terminal pins 16 of header connector 20 (FIG. 1). In other words, terminal pins 16A (FIG. 14) comprise portions of a plurality of male terminals, generally designated 74. Each male terminal 74 includes a pair of crimp arms 76 which are clamped to the interior core or wire 78 of a respective conductor 72. Each male terminal 74 also includes a pair of crimp arms 80 which are clamped onto the outer dielectric or insulating sheath 82 of the respective conductor. Of course, connector 12 of the invention can be used for mating with discrete terminal pins of a wide variety of electrical connecting devices, as exemplified by terminal pins 16 of header connector 20 and terminal pins 16A of male terminals 74.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

We claim:

1. A connector for electrically interconnecting the conductors of a flat flexible circuit to a plurality of discrete terminal pins, comprising:
a dielectric housing having a front mating face and a rear terminating face, a plurality of terminal pin receiving passages in the mating face and a flat circuit receiving receptacle in the terminating face, the receptacle communicating with the passages; and
a circuit carrier insertable into said receptacle of the housing and including an attachment portion for attaching the flat flexible circuit to the carrier with the conductors of the circuit facing away from the carrier toward the terminal pin receiving passages, whereby insertion of the pins in the passages causes the pins to engage the conductors of the circuit.

2. The connector of claim 1 wherein said circuit carrier is fabricated of metal material.

3. The connector of claim 1 wherein said circuit carrier includes a spring loaded mouth into which the terminal pins are inserted into engagement with the conductors of the circuit.

4. The connector of claim 3 wherein said housing includes cam means engageable with the circuit carrier to open said spring loaded mouth a given amount to apply a given contact force between the terminal pins and the conductors of the circuit.

5. The connector of claim 1, including complementary interengaging latch means between the circuit carrier and the housing to hold the carrier in the receptacle of the housing.

6. The connector of claim 1 wherein at least a portion of said circuit carrier is generally U-shaped to define a pair of legs, a first of said legs comprising said attachment portion of the carrier, and a second of said legs comprising a mounting portion for mounting the circuit carrier to the housing.

7. The connector of claim 6 wherein said first leg of the circuit carrier has a leading edge about which the flat flexible circuit is wrapped with the conductors of the circuit facing away therefrom.

8. The connector of claim 7 wherein said first leg of the circuit carrier includes a raised area immediately inside said edge and over which the flat flexible circuit is wrapped, the raised area forming contact portions behind the conductors for engaging the terminal pins.

9. The connector of claim 8 wherein said raised area is provided by a yieldable backing strip adhered to the inside of said first leg.

10. The connector of claim 6 wherein distal ends of said legs define a mouth at which the flat flexible circuit is attached for engaging the terminal pins inside the mouth.

11. The connector of claim 10 wherein said circuit carrier is spring loaded at said mouth, and the housing includes cam means engageable with at least one of the legs to open the mouth a given amount to apply a given contact force between the terminal pins and the conductors of the circuit.

12. The connector of claim 11 wherein said cam means comprises at least one cam ramp on the housing for opening said mouth automatically in response to inserting the circuit carrier into the receptacle of the housing.

13. A connector for electrically interconnecting the conductors of a flat flexible circuit to a plurality of discrete terminal pins, comprising:
a dielectric housing having a front mating face and a rear terminating face, a plurality of terminal pin receiving passages in the mating face and a flat circuit receiving receptacle in the terminating face, the receptacle communicating with the passages; and
a metal circuit carrier insertable into said receptacle of the housing, at least a portion of the circuit carrier being generally U-shaped to define a pair of legs, a first of said legs having a leading edge about which the flat flexible circuit is wrapped with the conductors of the circuit facing away therefrom toward the terminal pin receiving passages, a second of said legs comprising a mounting portion for mounting the circuit carrier to the housing, and the distal ends of the legs defining a spring loaded mouth into which the terminal pins are inserted into engagement with the conductors of the flat flexible circuit.

14. The connector of claim 13 wherein said housing includes cam means engageable with at least one of the legs to open the mouth a given amount to apply a given contact force between the terminal pins and the conductors of the circuit.

15. The connector of claim 14 wherein said cam means comprises at least one cam ramp on the housing for opening said mouth automatically in response to inserting the circuit carrier into the receptacle of the housing.

16. The connector of claim 15 wherein said second leg of the circuit carrier is fixed to the housing, and the first leg is moved by said cam ramp to open said mouth.

17. The connector of claim 13, including complementary interengaging latch means between the circuit carrier and the housing to hold the carrier in the receptacle of the housing.

18. The connector of claim 13 wherein said first leg of the circuit carrier includes a raised area immediately inside said edge and over which the flat flexible circuit is wrapped, the raised area forming contact portions behind the conductors for engaging the terminal pins.

19. The connector of claim 18 wherein said raised area is provided by a yieldable backing strip adhered to the inside of said first leg.

20. A connector for electrically interconnecting the conductors of a flat flexible circuit to a plurality of terminal pins, comprising:
a housing having a front mating end for receiving the terminal pins and a rear terminating end for receiving the flat flexible circuit; and
a circuit carrier insertable into the rear terminating end of the housing for supporting the flat flexible circuit with the conductors facing away therefrom for engaging the terminal pins inserted into the mating face of the housing.

21. The connector of claim 20 wherein said circuit carrier is fabricated of metal material.

22. The connector of claim 20 wherein said circuit carrier includes a spring loaded mouth into which the terminal pins are inserted into engagement with the conductors of the circuit.

23. The connector of claim 22 wherein said housing includes cam means engageable with the circuit carrier to open said spring loaded mouth a given amount to apply a given contact force between the terminal pins and the conductors of the circuit.

24. The connector of claim 20, including complementary interengaging latch means between the circuit carrier and the housing to hold the carrier in the receptacle of the housing.

25. The connector of claim 20 wherein at least a portion of said circuit carrier is generally U-shaped to define a pair of legs, a first of said legs comprising said support portion of the carrier, and a second of said legs comprising a mounting portion for mounting the circuit carrier to the housing.

26. The connector of claim 25 wherein said first leg of the circuit carrier has a leading edge about which the flat flexible circuit is wrapped with the conductors of the circuit facing away therefrom.

27. The connector of claim 26 wherein said first leg of the circuit carrier includes a raised area immediately inside said edge and over which the flat flexible circuit is wrapped, the raised area forming contact portions behind the conductors for engaging the terminal pins.

28. The connector of claim 27 wherein said raised area is provided by a yieldable backing strip adhered to the inside of said first leg.

29. The connector of claim 25 wherein distal ends of said legs define a mouth at which the flat flexible circuit is attached for engaging the terminal pins inside the mouth.

30. The connector of claim 29 wherein said circuit carrier is spring loaded at said mouth, and the housing includes cam means engageable with at least one of the legs to open the mouth a given amount to apply a given contact force between the terminal pins and the conductors of the circuit.

31. The connector of claim 30 wherein said cam means comprises at least one cam ramp on the housing for opening said mouth automatically in response to inserting the circuit carrier into the mating face of the housing.
